(19) United States
(12) Patent Application Publication
(10) Pub. No.: US 2023/0153496 A1
(43) Pub. Date: May 18, 2023

(54) RHEOLOGICAL MODEL OF WATER-IN-OIL EMULSIONS OBTAINED BY ARTIFICIAL INTELLIGENCE

(71) Applicant: Petróleo Brasileiro S.A. - Petrobras, Rio de Janeiro (BR)

(72) Inventors: Luis Kin Miyatake, Rio de Janeiro (BR); Marcia Cristina Khalil De Oliveira, Rio de Janeiro (BR); Thiago Geraldo Da Silva, Rio de Janeiro (BR); Andre Gonçalves Medeiros, Vitória (BR); Rafael Madeira Estevam Barbosa, Rio de Janeiro (BR); Felipe Mauro Rena Cardoso, Vitória (BR); Otavio Ciribelli Borges, Rio de Janeiro (BR)

(21) Appl. No.: 17/989,829

(22) Filed: Nov. 18, 2022

(30) Foreign Application Priority Data
Nov. 18, 2021 (BR) 10 2021 023210 2

(51) Int. Cl. G06F 30/28; G06F 30/27

(52) U.S. Cl. CPC G06F 30/28; G06F 30/27; G06F 2113/08

(57) ABSTRACT

The present invention refers to a method of evaluating the rheological properties of water-in-oil emulsions (W/O) in which it presents a new paradigm in the exploration and production segments generated using artificial intelligence in the analysis of rheological data of fluids produced in the Brazilian oil fields. The developed model makes it possible to predict the rheological properties of emulsions throughout the production life cycle of an oil field. The expected gains are associated with the use of correlations representative of the flow behavior of Brazilian oils, with the acceleration of the prioritization process of candidate wells for the demulsifier subsea (DSS) injection of chemical products and, consequently, with the increase in the production of oil and gas with subsequent value generation.

### CROSS-REFERENCE TO RELATED APPLICATION

This application claims priority to Brazilian Application No. 10 2021 0232102, filed on Nov. 18, 2021, and entitled “RHEOLOGICAL MODEL OF WATER-IN-OIL EMULSIONS OBTAINED BY ARTIFICIAL INTELLIGENCE,” the disclosure of which is incorporated herein by reference in its entirety.

### FIELD OF INVENTION

The present invention refers to a rheological model of water-in-oil emulsions by artificial intelligence applied in oil-producing wells that may present production losses due to load losses and flow instability caused by the effect of stable emulsion formation, making it possible to predict the properties of emulsions throughout the production life cycle of an oil field.

### DESCRIPTION OF THE STATE OF THE ART

Water-in-oil (W/O) emulsions are formed in most producing fields from the beginning of water production, during flow from the downhole to the surface installation. Typically, emulsions have high viscosities and stability, which can cause increased load losses during flow, production instability and oil losses.

The stability of the formed emulsion and the associated viscosity increment can significantly affect the production systems capacity, especially of those located in an offshore environment. In this sense, knowledge of the rheological properties of oils and their emulsions is of vital importance for defining the design bases to be adopted for dimensioning the production facilities, defining the fluid pumping requirements, moving and processing of these systems.

The rheological properties, in particular the viscosity, are important parameters to evaluate the properties and stability of oil emulsions. The viscosity of a W/O emulsion is associated with several factors, including: the volumetric fraction of the internal phase (water), ϕ; the density and viscosity of the external phase (oil); temperature; shear rate; distribution and average size of the drops; and presence of solids (clay, fouling, paraffin crystals and others).

The viscosity of an emulsion (µE) has a proportional relationship with the viscosity of its external phase (µFE Thus, the emulsion viscosity can be expressed from the term relative viscosity (µR), Equation 1. This term represents the oil viscosity increment when water is incorporated in the form of a water-in-oil (W/O) type emulsion.

$${μ}_{R} = \frac{{μ}_{E}}{{μ}_{F E}}$$

Einstein was the first to define a relationship between the relative viscosity of diluted emulsions (ϕ < 5%) and the volumetric fraction of the internal phase (ϕ), given by Equation 2.

$${μ}_{R} = 1 + 2 , 5. ϕ$$

Later works demonstrated that, for systems with higher water contents, expressions in the form of a power series can be used, represented by Equation 3.

$${η}_{R} = 1 + {a}_{0} . ϕ + {a}_{1} . {ϕ}^{2} + {a}_{2} . {ϕ}^{3} + … + {a}_{n} . {ϕ}^{\left(n + 1\right)}$$

where, α, α₁, α₂, ... , αn are constants, and the value of α₀ is usually equal to 2.5.

Richardson developed Equation 4 based on an exponential relationship between the relative viscosity and the volumetric fraction of the internal phase.

$$ln {μ}_{n} = b . ϕ$$

where, b is a proportionality constant.

Broughton and Squires, with the aim of rendering the logarithm of relative viscosity a linear function of the internal phase volumetric fraction, incorporated a constant (e) into Equation 4, obtaining Equation 5. However, this an inexact equation when ϕ tends to zero.

$$ln {μ}_{n} = c + b . ϕ$$

The viscosity increment, associated with the emulsion formation, can cause an increase in the pressure gradient in the flow. In the case of production systems, this load loss increase may, in principle, represent a reduction in oil production.

The correlations most used in commercial flow simulators to determine the emulsion viscosity are those of Woelflin and Ronningsen. In the study developed by Woelflin, three curves were built that correlate the viscosity of the W/O emulsion to the emulsified water content. Additionally, these curves were named as weak, medium or strong emulsions. After adjusting the data, Equation 6 was obtained:

$$\frac{{η}_{e}}{{η}_{o}} = {e}^{\left(a ∗ {ϕ}^{2} + b ∗ ϕ\right)}$$

Where ηₑ and η₀ are, respectively, the kinematic viscosity of the emulsion and the oil phase and ϕ is the water fraction. The coefficients a and b were defined according to the type of emulsion considered.

A study developed by Ronningsen, based on only eight North Sea oils, with API degrees between 20 and 40, presented a general empirical equation that provides estimates for the relative viscosity of emulsions at temperatures between 5 and 40° C., water fractions between 10% and 60% and shear rates between 300 and 500 S⁻¹, according to equation 7:

$$ln {μ}_{R} = {k}_{1} + {k}_{2} ∗ T + {k}_{3} ∗ ϕ + {k}_{4} ∗ T ∗ ϕ$$

In this expression, T is the temperature and k1, k2, k3 and k4 are constants, adjusted experimentally, which must be defined as a function of the shear rate.

Another factor that must be considered is that throughout the production flow, from the well to the platform, there is the presence of gas, initially dissolved in the oil and being released as the pressure decreases. Thus, the fluid viscosity undergoes changes due to the release of gas and temperature change.

The correlations developed so far are able to predict the viscosity of oil emulsions, but considerable deviations are observed in oils with different densities and in a range of shear rates outside the expected range in the wells flow and Petrobras subsea lines, thus being different from the one defined in the present invention.

Thus, the rheological properties of oil and emulsions were typically measured by laboratory tests, with fluids collected in the production fields during formation and production tests of a well. Saline water was incorporated into the oil in different proportions, from 10% to 70%, to generate emulsions representative of the flow, considering the increase in water production over the productive life of a well. The rheological analyzes of emulsions with different water contents were carried out in oils of 15 to 40° API from different regions of Brazil at different temperatures, from 4 to 70° C., in the range of shear rate from 20 to 250 s⁻¹.

The viscosity data obtained in the laboratory were fed in flow simulators to predict the fluids behavior, considering the geometric data of the production lines and the temperature and pressure conditions of the scenario. These simulators use the previously mentioned empirical mathematical correlations to describe the flow, which were developed from data on some North Sea oils and other regions of the world.

Information concerning the flow behavior is used to understand field occurrences, to evaluate alternatives to improve flow and, consequently, increase oil production. This process implied high logistical and personnel costs, related to sample collection, transport and rheological analysis of samples in the laboratory, and also in obtaining simulation data with low representation of Brazilian scenarios. Thus, it arises the need for a method for predicting the rheological behavior of petroleum emulsions without the need to collect samples and analyze them in the laboratory.

FERRAZ, L. A. (2015) “Comportamento reológico de emulsões do tipo água em óleo de petróleos pesados: estudo experimental e avaliacão correlações empíricas” (“Rheological behavior of water-in-oil emulsions of heavy oils: experimental study and evaluation of empirical correlations”), Dissertation (Master in Energy) - Federal University of Espírito Santo - São Mateus, evaluates some of the main empirical correlations aimed at predicting the viscosities of water-in-oil (W/O) emulsions present in two of the most prominent multiphase flow simulators (OLGA®, PIPESIM®). Four oil samples from oil wells in Northern Capixaba onshore fields, with API degrees between 13 and 23 were collected, and the influences of temperature, volumetric fraction of the dispersed phase and shear rate on the relative viscosities of the emulsions were evaluated using the experiment planning technique.

OLIVEIRA, C. B. Z. (2010) “Reologia de petróleos e suas emulsões do tipo A/O” (“Rheology of oils and their W/O type emulsions”) Dissertation (Master in Process Engineering) - Tiradentes University - Aracaju, evaluates the effect of a variable set on the rheological behavior of oil emulsions, including average drop diameter, salinity, pH and water content.

In the article by AZODI, M.; NAZAR, A. R. S. (2013) “An experimental study on factors affecting the heavy crude oil in water emulsions viscosity”, Journal of Petroleum Science and Engineering, v. 106, p.1-8 describes a modified rheological equation to predict oil-in-water emulsion viscosity based on factors that affect viscosity. This equation is developed based on shear rate, oil concentration, emulsifier concentration and temperature.

However, no state-of-the-art document reveals a rheological model of W/O emulsions, by artificial intelligence, which makes it possible to predict the rheological behavior of oil emulsions without the need to collect samples and laboratory analyzes such as the present invention.

Thus, in order to solve such problems, the present invention was developed, which enables the prediction of rheological properties of emulsified fluids using data-oriented models of Brazilian oils, through artificial intelligence techniques.

The present invention presents technical advantages such as: a model based on data from Brazilian fields, reliability increment in the elevation modeling and flow, evaluation and quantification of production gains with demulsifier subsea (DSS) injection, in addition of being incorporated into commercial flow models.

Further, the present invention presents economic advantages, such as: prioritization of wells in the DSS injection, anticipation in decision-making to increase production and reduction of logistical costs for fluid sampling.

### BRIEF DESCRIPTION OF THE INVENTION

The present invention refers to a rheological model of emulsions from water-in-oil type by artificial intelligence, which makes it possible to predict the rheological behavior of petroleum emulsions without the need to collect samples and laboratory analyzes and that was developed by processing the database generated over the last few years 10 years using artificial intelligence.

The present invention can be applied in all scenarios of oil producing wells that may present production losses due to load losses and flow instability caused by the effect of stable emulsion formation.

### BRIEF DESCRIPTION OF DRAWINGS

The present invention will be described in more detail below, with reference to the attached figures which, in a schematic and not limiting of the inventive scope, represent examples of its realization. In the drawings, there are:

FIG. 1 represents the model Extra Trees (X), the input data: 1) water fraction, 2) temperature, 3) API density and 4) viscosity of the dehydrated petroleum, and the output data; 5) Log of relative viscosity. It is noteworthy that items 3 and 4 are differentials of the present invention;

FIGS. 2A-2F illustrates the results of relative viscosity (y axis) as a function of the water fraction (x axis) obtained by the model Extra Trees, compared to classical literature models. In these graphs, the performance of the model is also compared in the training and test sets, sampled in the laboratory, for 6 wells (among 174 present in the dataset used to build the model), for a relative viscosity of 50° C. well 1 (FIG. 2A); well 2 (FIG. 2B); well 3 (FIG. 2C); well 4 (FIG. 2D); well 5 (FIG. 2E); and well 6 (FIG. 2F). It is observed that the wells have significant adaptability, behaving similarly and adaptively to the classic model (Woelflin Weak, Woelflin Medium, Woelflin Strong or Ronningsen) most suitable to the well. This ability to adapt is due to the inclusion of two new inputs to the model: viscosity of the dehydrated oil and API density, inputs that are relevant for differentiating between oils and, therefore, important for rheological characterization;

FIG. 3 illustrates the comparison of measured and simulated background pressure values (well bottom hole pressure) with the model Extra Trees using the Involuta simulator for a production history set with a window of 204 tests in 6 different wells.

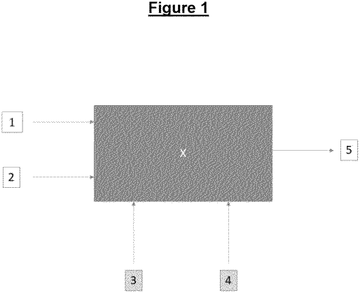

### DETAILED DESCRIPTION OF THE INVENTION

The rheological model of water-in-oil emulsions by artificial intelligence, according to the present invention, comprises:
(a) Accessing the database of fluids produced from Brazilian reservoirs;
(b) Evaluating oil and emulsion rheological data based on input parameters, fluid data such as oil API density, water content, temperature and viscosity of dehydrated oil to build a regression model (Extra Trees) and determine the relative viscosity of the emulsion using a supervised learning framework;
(c) Coupling the flow simulator with an artificial intelligence model, where the artificial intelligence model is the ensemble type, known as Extra Trees;
(d) Using a flow simulator (at steady state) using empirical mathematical correlations to describe the flow, as well as the emulsion viscosity model coupled to the simulator’s calculation engine;
(e) Estimating the relative viscosity profile as a function of the water fraction for subsea injection of demulsifying products in producing wells.

The artificial intelligence model selected to predict the relative viscosity of emulsions uses an ensemble-type method known as Extra Trees. Ensembles are machine learning models made up of other simpler models (base learners) with the aim of improving prediction performance. The main idea of the methodology is to combine a set of models in such a way that the global composition of the model obtains more accurate and reliable results or decisions than those that can be obtained with a single model (KOZAK, J. “Decision Tree and Ensemble Learning Based on Ant Colony Optimization”, Springer, 2019). In this sense, the operating principle of ensembles is related to the human nature of seeking opinions from different specialists before making an important decision (POLIKAR, R. “Ensemble Machine Learning - Methods and Applications”, Springer, p.1-32, 2012).

The common structure of an ensemble can be such that the constituent models (base learners) can be arranged in parallel or in series. We emphasize the parallel construction, in which each base model is built independently and directly from the database. One of the characteristics of this technique is the reduction of variance in the predictions.

The Extremely Randomized Trees or Extra-Trees model is an ensemble formed by decision trees allocated in parallel, where the entire training dataset is used in the “growth” of each tree. Decision trees are formed by a root node, child nodes and leaf nodes; their structure is formed through successive data divisions, at each node, until the formation of a leaf, according to a stopping criterion in the divisions. In this context, the algorithm of the Extra Trees performs the training of its trees by determining the node division rules based on a randomly chosen subset of features and a cutoff point (GEURTS, P. et al., “Extremely randomized trees”, Machine Learning, v. 63, p.3-42, 2006).

From the trained model, in the case of a regression problem, the value inferred by the ensemble is given by the arithmetic mean of the values obtained in each of the trees (GEURTS, P. et al., “Extremely randomized trees”, Machine Learning, v. 63, p.3-42, 2006).

The rheological data of fluids produced in different Brazilian reservoirs were generated by the oil flow and emulsions laboratory over the last ten years. This systematic collection of fluids for characterization generated a large database that enabled its use in a machine learning framework, more specifically in a supervised learning problem. This problem is a regression, in which the artificial intelligence model infers the viscosity of the emulsion based on input parameters, such as the API density of the oil, water content, temperature and viscosity of the dehydrated oil. A set of machine learning models was tested and, through a model selection procedure, the most appropriate was selected based on its ability to generalize on a test set.

The artificial intelligence model, object of the present invention, uses an ensemble-type method, known as Extra Trees. This regression, built with more than 2000 data from rheological tests obtained in the laboratory, using a variety of oils with different characteristics, presents low error metrics both in the training sets and in the test data. In addition, the estimated profile of relative viscosity as a function of the water fraction is consistent with what is expected in physical terms, showing breakdown of the emulsion with water content above 70%.

The method has adequate generalization ability. To evaluate its performance, a coupling of the model was made. Extra Trees with the simulator in steady state. More than 200 production tests were used (not previously observed by the artificial intelligence model) and the errors in terms of downhole pressure have an absolute average error value of less than 5%. Additionally, it was observed that the generated model presents better correlation with the field data than the classic models used in the flow simulators.

This approach can decrease the frequency in which fluids are collected in the field and analyzed in the laboratory, reducing logistical and personnel costs. In addition, upon using the artificial intelligence model coupled to a flow simulator, it will be possible to simulate the flow of oil and emulsion and decide more quickly and confidently on the prioritization of subsea injection of demulsifying products in producing wells, allowing an anticipation of the revenue and its consequent generation of value.

### EXAMPLES

The following examples are presented in order to more fully illustrate the nature of the present invention and the way to practice the same, without, however, being considered as limiting its content.

After years analyzing Brazilian oils, produced in the Campos Basin, Espirito Santo Basin and Santos Basin, a considerable volume of different densities oils viscosity data was generated, depending on the water content, temperature and the shear rate.

This database was evaluated and made it possible to obtain a flow model from the artificial intelligence technique. With the implementation of the model, object of this invention, in flow simulators, a considerable part of fluids not evaluated in the laboratory, in production or in the design phase, can have their rheological characteristics estimated in advance based on basic oil characteristics. This allows technological alternatives to increase well production, such as subsea demulsifier injection (DSS), to be identified more quickly, accelerating significant gains in oil production.

The invention results make it possible to know the flow behavior of oil with different water contents (emulsions) and also perform a decision-making strategy regarding the prioritization of DSS injection in order to gain oil production.

In terms of modeling, they increase the reliability of elevation and flow models, especially in the case of emulsified fluids, allowing a better understanding of simulated results compared to data observed in the field.

This improvement is due to the fact that the regression model, which estimates the relative viscosity of the oil, receives new inputs that allow to improve and specialize the emulsion model for the Brazilian basins, using a set of data collected in the laboratory.

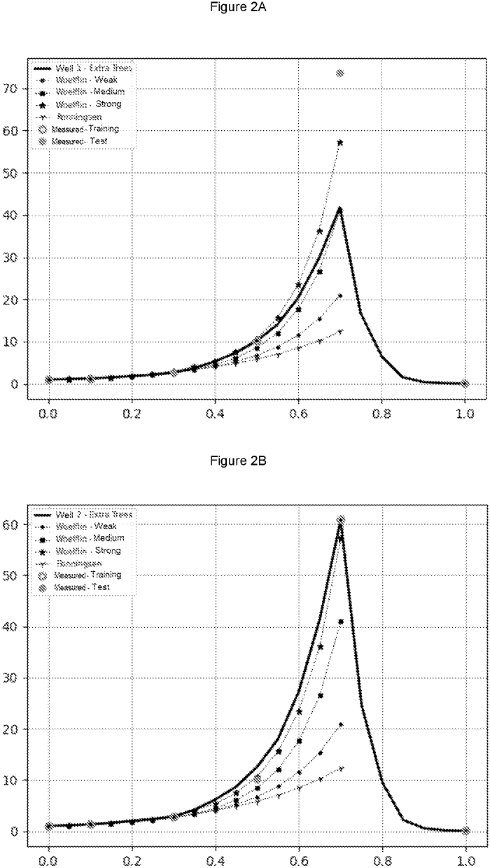

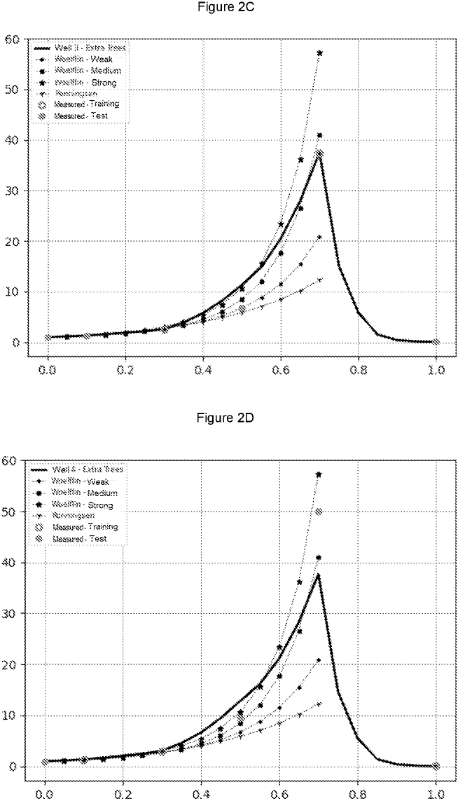

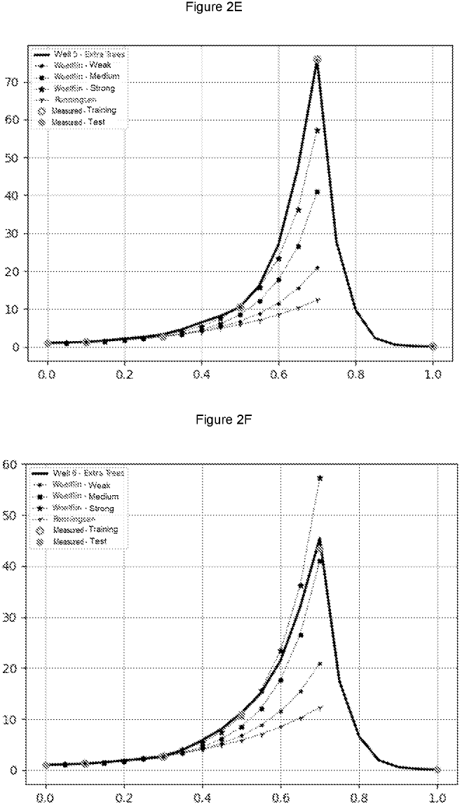

As can be seen in FIG. 2, relative viscosity graphs are displayed as a function of water content for 6 wells using the classic models (Woeflin, and Ronningsen) and the model developed for comparison. It is noted that the proposed model fits well to the data measured in the laboratory, maintaining good performance in the training (dots in empty gray) and test (dots in solid gray) set. In addition, it satisfactorily demonstrates the expected behavior for relative viscosity, showing emulsion breakdown (phase separation) with water content greater than 70%.

It is noted that the model Extra Trees has an adaptive capacity, that is, it is able to identify the behavior of emulsions according to their stability using the new input data (API and viscosity of the dehydrated oil).

It should be noted that, although the present invention has been described in relation to the attached drawings, it may undergo modifications and adaptations by technicians versed in the subject, depending on the specific situation, but provided that it is within the inventive scope defined herein.

### Extra Trees Integration - Involuta

The emulsion model Extra Trees was integrated into the multiphase steady-state flow simulator Involuta, owned by Petróleo Brasileiro S.A. This simulator is based on mechanistic models presented in GOMEZ, L. et al. (2000) “Unified mechanistic model for steady-state two-phase flow: Horizontal to vertical upward flow”, SPE Journal, Society of Petroleum Engineers (SPE), v. 5, n. 03, p. 339-350 for the hydraulic calculation with modifications in the closing ratios.

The calculation mechanism of the Involuta simulator considers the flow section geometry separated into sections and uses the modeling of fluid properties to calculate the pressure and temperature profiles along the flow. This way, for each section during the simulation, the model Extra Trees receives, as input data, the API grade of the oil, the average temperature of the section, the viscosity of the dead oil at the section temperature and the water fraction at the section pressure and temperature. The output data of the model Extra Trees for the Involuta simulator, is the estimated value of the relative viscosity of the liquid flowing through each section.

### Simulation Results

The performance of the integrated model Extra Trees - Involuta was evaluated by simulating real producing wells, comparing background pressures measured in the field during production tests with simulated pressures. Six (6) producing wells were considered, all producing with lift gas as a lifting method and located in Brazilian offshore fields.

In total, 204 production tests were simulated. Table 1 shows the variation range of some parameters of the tests involved. Only production tests with a water fraction greater than 20% were considered, in order to exclude conditions in which the emulsion plays an irrelevant role.

TABLE 1

Variation range of production test parameters

| Parameter | Minimum | Maximum |
|---|---|---|
| Liquid flow (m³/d) | 135 | 2686 |
| Downhole pressure (Kgf/cm²) | 77 | 261 |
| Water fraction (%) | 20 | 70 |
| API Density (◦) | 221 | 32 |

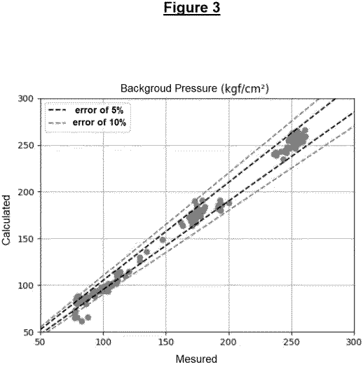

FIG. 3 shows the comparison between the measured background pressure and the simulated background pressure in the production tests. There is an average absolute error of 3.5% and an average error of 4.2 kgf/cm². It can be seen, therefore, that the integrated model had a good performance over a wide range of flow conditions (see Table 1), demonstrating its robustness. This feature is extremely important for flow simulators, as with a reliable model, anomalies can be identified in advance and actions can be taken to restore the production.

1. RHEOLOGICAL MODEL OF WATER-IN-OIL EMULSIONS OBTAINED BY ARTIFICIAL INTELLIGENCE, characterized by comprising the following steps:
(f) Accessing the database of fluids produced from Brazilian reservoirs;
(g) Evaluating oil and emulsion rheological data based on input parameters and fluid data to build a regression model, and determining the relative viscosity of the emulsion using a supervised learning framework;
(h) Coupling the flow simulator with an artificial intelligence model;
(i) Using a flow simulator at steady state using empirical mathematical correlations to describe the flow, as well as the emulsion viscosity model coupled to the simulator’s calculation engine;
(j) Estimating the relative viscosity profile as a function of the water fraction for subsea injection of demulsifying products in producing wells.

2. MODEL, according to claim 1, characterized in that the rheological data is the API density of the oil, water content, temperature and viscosity of the dehydrated oil.

3. MODEL, according to claim 1, characterized in that the artificial intelligence model is the ensemble type, such as Extra Tree.
